(19) United States
(12) Patent Application Publication
(10) Pub. No.: US 2022/0127872 A1
(43) Pub. Date: Apr. 28, 2022

(54) SUPPORTING BASE, TABLE BODY AND OUTDOOR UMBRELLA

(71) Applicant: Mengna XUN, Yuncheng (CN)

(72) Inventors: Tianyi CHEN, Quanzhou (CN); Mengna XUN, Yuncheng (CN)

(73) Assignee: Mengna XUN, Yuncheng (CN)

(21) Appl. No.: 17/427,100

(22) PCT Filed: Jan. 21, 2020
(86) PCT No.: PCT/CN2020/073375

§ 371 Date: Jul. 30, 2021

(30) Foreign Application Priority Data
Jan. 30, 2019 (CN) 201920163606.5
Jan. 19, 2020 (CN) 202020119397.7

(51) Int. Cl. E04H 12/22; A45B 23/00; A47B 37/04

(52) U.S. Cl. CPC E04H 12/2238; A45B 23/00; E04H 12/2223; A45B 25/08; A45B 2023/0012; A45B 2200/1063; A47B 37/04

(57) ABSTRACT

A supporting base and an outdoor umbrella using the supporting base are provided. The supporting base includes a supporting post, a plurality of supporting legs and a bottom pad. The supporting legs are hinged to a lower end of the supporting post. The supporting post is configured to connect an object to be supported. The bottom pad is a flexible bottom pad, and the bottom pad is connected to the supporting legs and arranged under the supporting legs. When the supporting legs are flipped to a supporting base placement surface along a hinge joint of the supporting leg and the supporting post, the bottom pad is located between the supporting legs and the supporting base placement surface and attached to the supporting base placement surface. The outdoor umbrella is fixedly placed by using the supporting base. The bottom pad is spread by the supporting legs.

### CROSS REFERENCE TO THE RELATED APPLICATIONS

This application is the national phase entry of International Application No. PCT/CN2020/073375, filed on Jan. 21, 2020, which is based upon and claims priority to Chinese Patent Applications No. 201920163606.5, filed on Jan. 30, 2019; and No. 202020119397.7, filed on Jan. 19, 2020, the entire contents of which are incorporated herein by reference.

### TECHNICAL FIELD

The present invention relates to the field of leisure products, and more particularly, to a supporting base, a table body and an outdoor umbrella.

### BACKGROUND

With the progress of society, when people are playing outside, conducting open-air marketing, carrying out outdoor public welfare activities, or the like, they often need to place tables, umbrellas, warning signs, billboards and others. In the required positions, the placement of these items requires a base.

Chinese patent application 201720769472.2 discloses a multifunctional sun umbrella. The multifunctional sun umbrella includes a shaft, ribs arranged on the shaft and a canopy matched with an outer surface of the ribs. A connecting base is fixedly arranged on the shaft. At least two pivot grooves are arranged on the connecting base. A limiting portion is arranged at the bottom of each pivot groove. A supporting rod is pivotally connected in each pivot groove. A table top is arranged on the supporting rod. The base of the sun umbrella is supported by a bottom supporting rod and an inclined supporting rod. The aforementioned solution, however, has the following shortcomings. First, umbrellas, especially outdoor umbrellas, are prone to tip over due to a high center of gravity and be blown by wind due to a large canopy. For this reason, most of the outdoor umbrellas require a large-area base or a weight for stabilization, and such problems also exist in the aforementioned solution. Second, outdoor umbrellas are required to apply to a variety of occasions, such as beaches and grass grounds. The aforementioned solution is obviously not suitable for sandy ground, river beaches with many stones and grass ground with much debris, which limits its application. Third, the base of the aforementioned solution cannot receive other items for placement.

### SUMMARY

In order to solve the above-mentioned problems, the present invention provides a supporting base, a table body and an outdoor umbrella.

The present invention adopts the following technical solutions:

A supporting base includes a supporting post, a plurality of supporting legs and a bottom pad, where the supporting legs are hinged to a lower end of the supporting post; the supporting post is configured to connect an object to be supported; the supporting leg is configured to be flipped to a supporting base placement surface along a hinge joint of the supporting leg and the supporting post to be fixed; the bottom pad is a flexible bottom pad; the bottom pad is connected to the supporting legs and arranged under the supporting legs; when the supporting leg is flipped to the supporting base placement surface along the hinge joint of the supporting leg and the supporting post, the bottom pad is located between the supporting legs and the supporting base placement surface and attached to the supporting base placement surface.

Further, the supporting base may be used to support a pole-shaped object, where the supporting post may be provided with an opening on a top surface; the opening on the top surface of the supporting post may be configured to be inserted by the pole-shaped object; the supporting base further may include a base body sleeve and a plurality of base body push-pull rods; the base body sleeve may be sleeved outside the object to be supported; the base body sleeve may be arranged above the supporting post; the base body push-pull rods are arranged in one-to-one correspondence to the supporting legs; a head end of the base body push-pull rod may be hinged to the middle of the corresponding supporting leg, and a tail end of the base body push-pull rod may be hinged to a side edge of the base body sleeve.

The base body sleeve may be provided with a base body bolt; the bolt may be locked and fastened to fixedly connect the base body sleeve with the object to be supported by locking and fastening; an adjustment washer may be arranged in the opening on the top surface of the supporting post and/or in the base body sleeve; the adjustment washer may be sleeved outside the object to be supported.

A bottom surface of the bottom pad may be provided with an anti-slip member; the bottom pad may be provided with a plurality of extension coverings; one extension covering may be arranged between each two adjacent supporting legs; adjacent extension coverings may be connected to each other; head ends of the plurality of extension coverings may be connected to a side edge of the object to be supported above the base body sleeve; a weight accommodating cavity for accommodating a weight may be formed between the extension covering and the bottom pad.

Head ends of the supporting legs may be hinged to a side edge of the supporting post; a supporting portion may be arranged at a tail end of each supporting leg; the supporting portion may be formed by bending the tail end of the supporting leg toward a side of the supporting leg away from the supporting post.

Further, a pole-shaped protrusion may be provided to support an object with a connection structure, where

the supporting post may be provided with an opening on a top surface; the supporting base further may include a supporting rod, a base body sleeve and a plurality of base body push-pull rods; a lower end of the supporting rod may be inserted into the opening on the top surface of the supporting post; the base body sleeve may be sleeved outside the supporting rod movably along a length direction of the supporting rod; the base body sleeve may be arranged above the supporting post; the base body push-pull rods are arranged in one-to-one correspondence to the supporting legs; a head end of the base body push-pull rod may be hinged to the middle of the corresponding supporting leg, and a tail end of the base body push-pull rod may be hinged to a side edge of the base body sleeve.

The supporting base further may include a ground drill handle and a drill bit; the ground drill handle may be arranged in the middle of the supporting rod, and the drill bit may be detachably assembled on a lower end surface of the supporting rod; an assembling through-hole may be formed in the center of the ground drill handle; the supporting rod passes through the assembling through-hole and may be pivotally connected to the ground drill handle through a pivot shaft arranged in the assembling through-hole.

The supporting base further may include a table body; the table body may be arranged at an upper end of the supporting rod; the table body may include an upper table body sleeve, a lower table body sleeve, at least three struts, at least three table body push-pull rods and a table top; the upper table body sleeve and the lower table body sleeve may be respectively sleeved on the supporting rod; head ends of the struts may be hinged to a side edge of the upper table body sleeve; the table body push-pull rods may are arranged in one-to-one correspondence to the struts; a head end of the table body push-pull rod may be hinged to the middle of the corresponding strut, and a tail end of the table body push-pull rod may be hinged to a side edge of the lower table body sleeve; the table top may be a flexible table top, and the table top may be placed on the struts.

The table top may be provided with a reflective warning portion; the reflective warning portion may be arranged on a side of the table top away from the struts; the reflective warning portion may be a reflective sticker or a reflective coating with a warning function.

An outdoor umbrella using the supporting base is fixedly placed by using the supporting base.

The above description of the present invention shows that compared with the prior art, the present invention has the following advantages:

1. The bottom pad is spread by the supporting legs, and the entire supporting base can be unfolded and folded, saving transportation space. A weight can be placed on the bottom pad to facilitate the supporting base to support an object with a high center of gravity and easy to tip over. The weight can be made of a locally available material, such as sand on the sandy beach, rocks on the river beach, and drinking water available locally. The supporting base can be used to support a pole-shaped object, such as a lower supporting rod of an outdoor umbrella, a colorful flag, a publicity sign or a warning sign, with wide applicability. The extension covering can hide the weight, which makes the whole supporting base more beautiful. In addition, the weight, for example, the sand, will not be blown by the wind to affect the use of the supporting base, and the weight can be well fixed even when the extension covering is closed.

2. The supporting base of the present invention is matched with a ground drill handle and a detachable drill bit. In the case of grass and soft grounds that can be drilled into, the supporting rod is pulled out from the supporting post, the drill bit is assembled, and the ground drill handle is held to directly drill the supporting rod into the ground. The support is completed by folding up the supporting post, the supporting legs and the bottom pad. The scope of application of the product is further expanded through the accessories, which can enhance the market competitiveness of the product.

3. The supporting base of the present invention is matched with a table body, which can improve the convenience of using the supporting base outdoors. Moreover, since the table top is provided with a reflective warning portion, when the table body is folded, the supporting base cooperates with the table body to form a warning sign. When a warning sign is needed temporarily on roads, publicity venues and other outdoor occasions due to accidents or insufficient preparations, the supporting base can be used for emergency. Since the stability of the supporting base is much greater than that of the warning signs for automobiles, the supporting base is more secure when used as a warning sign.

4. The bottom pad of the present invention is matched with the supporting legs with supporting portions. When the supporting base is used on a flat ground, the supporting portions press the bottom pad to contact the ground. Even if there is sand and debris on the ground, it will not affect the placement, and the multi-leg support is more stable than one-leg support. When the supporting base is used on the sandy ground, river beach, grass ground, etc., the supporting portions are pressed against the bottom pad to be embedded toward the placement ground, and the large surface of the bottom pad is in contact with the placement ground, so as to maintain the stability of the supporting base.

A supporting base may include a supporting post, a base body sleeve, a base body switch assembly, a plurality of supporting legs and a plurality of base body push-pull rods, where the base body push-pull rods are arranged in one-to-one correspondence to the supporting legs; head ends of the supporting legs may be hinged to a circumferential side edge of the bottom of the supporting post; a head end of the base body push-pull rod may be hinged to the middle of the corresponding supporting leg, and a tail end of the base body push-pull rod may be hinged to a circumferential side edge of the bottom of the base body sleeve; the supporting post may be a tubular structure with an opening on a top surface; the opening on the top surface of the supporting post may be configured to be inserted by a pole-shaped object to be supported; the bottom of the base body sleeve may be arranged above the bottom of the supporting post; the bottom of the supporting post and the bottom of the base body sleeve move towards or away from each other to unfold or fold the supporting legs; the base body sleeve may be movably sleeved outside the supporting post; when the supporting legs is in an unfolded state, the base body switch assembly may be configured to lock the relative movement between the base body sleeve and the supporting post or to remove the locked state.

The above description of the supporting base of the present invention shows that compared with the prior art, the present invention has the following advantages:

In the present invention, the supporting post is extended such that the base body sleeve is sleeved outside the supporting post, and the supporting post and the base body sleeve are connected through the base body switch assembly when the supporting base is in use. Thus, when the supporting base is in use, the relative movement between the bottom end of the supporting post and the bottom end of the base body sleeve is directly and firmly locked. This connection structure improves the connection strength, and improves the supporting effect of the supporting legs, making the supporting base more stable and significantly improving the supporting performance of the supporting base. In this structure, the supporting post bears all the functions of connecting with the supported object, and the base body sleeve is only used for the unfolding and folding of the supporting legs. As the functions are separated, each structure performs its duties and the overall product becomes more scientific, reasonable and stable.

Further:

the supporting base may include a bottom pad, and the bottom pad is a flexible bottom pad; the bottom pad may be connected to the supporting legs and arranged under the supporting legs; when the supporting legs is in an unfolded state, the bottom pad may be located between the supporting legs and a supporting base placement surface and attached to the supporting base placement surface.

A supporting portion may be arranged at the tail end of each supporting leg; the supporting portion may be formed by bending the tail end of the supporting leg toward a side of the supporting leg away from the supporting post.

Four supporting legs and four base body push-pull rods are arranged respectively; the bottom pad may be arranged in a square shape; four corners of a top surface of the bottom pad may be respectively provided with a connecting sleeve; the bottom pad may be sleeved outside the supporting portion through the connecting sleeve to realize connection with the supporting leg; the bottom pad may be further provided with a disassembling handle; the disassembling handle may be a flexible handle, and the disassembling handle may be arranged in any one of the four corners of the bottom pad.

The base body switch assembly may has a structure in which a latch mechanism arranged in one of the supporting post and the base body sleeve may be locked into the other of the supporting post and the base body sleeve; alternatively, the base body switch assembly may has a structure in which a pressing mechanism arranged in one of the supporting post and the base body sleeve presses a side edge of the other of the supporting post and the base body sleeve.

The base body switch assembly may include a base body limiting base and a base body switch fastener; the base body limiting base and the supporting post may be integrally formed on a circumferential outer edge of the supporting post; the base body switch fastener may be assembled in the base body sleeve; a circumferential outer edge of the base body limiting base is provided with a limiting groove with a ring-shaped structure; the base body switch fastener may be arranged in a ring shape; the base body switch fastener may be provided with a switch button, a limiting protrusion and at least one reset spring; the switch button may be arranged on a circumferential outer edge of the ring structure of the base body switch fastener; the limiting protrusion may be arranged on a circumferential inner side edge of the ring structure of the base body switch fastener; the switch button penetrates a side wall of the base body sleeve and extends to a circumferential outer edge of the base body sleeve; a protruding direction of the limiting protrusion and an extending direction of the switch button may be identical; the reset spring and the limiting protrusion may be arranged away from each other on the circumferential outer edge of the ring structure of the base body switch fastener; the reset spring abuts against an inner edge of the base body sleeve; a forced deformation direction of the reset spring may be consistent with a movement direction of the switch button after being pressed; there may be two reset springs, and the two reset springs may be arranged opposite to each other.

The above description of the supporting base of the present invention shows that compared with the prior art, the present invention has the following advantages:

The base body switch assembly of the present invention realizes locking and unlocking by snapping the protrusion into the groove or not, and only one switch fastener is required to cooperate with the limiting base. The structure is simple and the cost is low. Meanwhile, the protrusion automatically snaps in to lock, and the unlocking is realized simply by pressing, which is convenient and quick to use.

The supporting post may be provided with a top fixing portion and a bottom fixing portion; the top fixing portion may be arranged at the opening on the top surface of the supporting post; the top fixing portion may be a threaded variable-diameter locking structure; the bottom fixing portion may be arranged at the bottom of the supporting post; the bottom fixing portion may be a necking structure with an inner diameter gradually decreasing from top to bottom.

The above description of the supporting base of the present invention shows that compared with the prior art, the present invention has the following advantages:

The supporting base is provided with a top fixing portion and a bottom fixing portion, which widens the range of application of the supporting base. Compared with some existing fixing methods, for example, a threaded variable-diameter locking structure often used to fix the bottom end of the shaft of the outdoor umbrella, the two fixing portions better fix the supported object, preventing the supported object from shaking due to the difference between the outer diameter of the supported object and the inner diameter of the supporting post. The threaded variable-diameter locking structure is very common in the field of outdoor products, and when it is used as the top fixing portion, it is convenient to use, highly acceptable to consumers, and is convenient to purchase and replace. The bottom fixing portion is a necking structure with an inner diameter gradually reducing from top to bottom, which has obvious advantages in low design difficulty and cost. Compared with the solution without the bottom fixing portion, the solution of adding the necking structure does not increase the cost but brings a very significant effect.

A table body includes an upper table body sleeve, a lower table body sleeve, at least three struts, at least three table body push-pull rods and a table top, where a head end of the strut is hinged to a side edge of the upper table body sleeve; the table body push-pull rods are arranged in one-to-one correspondence to the struts; a head end of the table body push-pull rod is hinged to the middle of the corresponding strut, and a tail end of the table body push-pull rod is hinged to a side edge of the lower table body sleeve; the table top is a flexible table top, and the table top is placed on the struts; the top of the upper table body sleeve and the top of the lower table body sleeve move towards or away from each other to unfold or fold the struts; the table body is placed in an application position through a supporting rod; the table body further includes a table body switch assembly; when the struts are in an unfolded state, the bottom of the upper table body sleeve is located in the lower table body sleeve, and the table body switch assembly is configured to lock the relative movement between the upper table body sleeve and the lower table body sleeve or to remove the locked state; the upper table body sleeve and the lower table body sleeve are respectively sleeved outside the supporting rod; at least one of the upper table body sleeve and the lower table body sleeve is connected to the supporting rod.

### BRIEF DESCRIPTION OF THE DRAWINGS

FIG. 1 is a schematic structural diagram of an outdoor umbrella (not shown) with a supporting base according to Embodiment 1 of the present invention.

FIG. 2 is a partial exploded view of the outdoor umbrella according to Embodiment 1 of the present invention.

FIG. 3 is a partial cross-sectional view of the outdoor umbrella according to Embodiment 1 of the present invention.

FIG. 4 is a schematic structural diagram of the supporting base according to Embodiment 1 of the present invention, where a table top, a bottom pad and an extension covering are not shown.

FIG. 5 is a schematic structural diagram of a supporting base according to Embodiment 2 of the present invention, where a bottom pad and an extension covering are not shown.

FIG. 6 is a schematic structural diagram of a table body assembled with a supporting base according to Embodiment 3 of the present invention.

FIG. 7 is an exploded view of a base body switch assembly of the supporting base according to Embodiment 3 of the present invention.

FIG. 8 is an exploded view of a table body switch assembly of the table body according to Embodiment 3 of the present invention.

### DETAILED DESCRIPTION OF THE EMBODIMENTS

The specific implementations of the present invention are described below with reference to the accompanying drawings.

### Embodiment 1

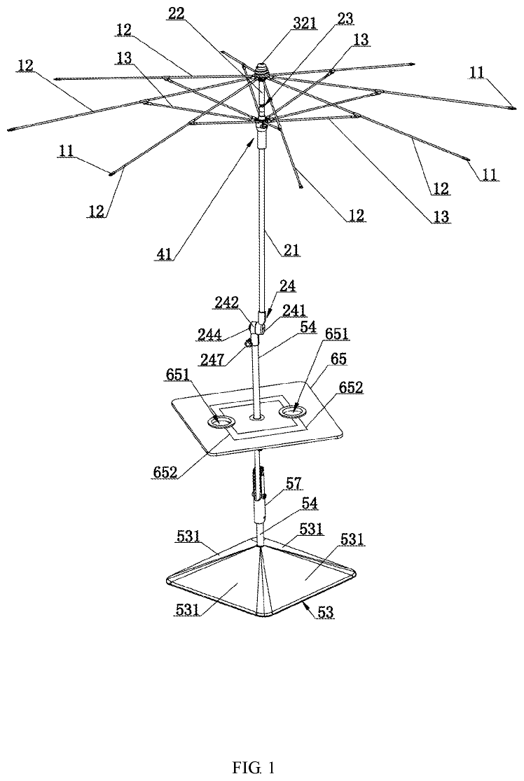

Referring to FIGS. 1, 2 and 4, an outdoor umbrella includes ribs and a canopy. The ribs are used to place and support the canopy. The ribs include a shaft, an upper runner, a lower runner and a plurality of supporting assemblies. A head end of the shaft is used to place the umbrella. The upper runner is located at a tail end of the shaft. The lower runner is movable along the shaft. A head end of the supporting assembly is hinged on side edges of the upper runner and the lower runner. The upper runner and the lower runner move towards or away from each other to drive the supporting assembly to unfold or fold. The outdoor umbrella is placed on a supporting base. The supporting base is provided with a supporting rod. The supporting rod is connected to the head end of the shaft to support the shaft.

Referring to FIG. 1, each supporting assembly includes a tip 11, a long rib 12 and a linkage rod 13. A head end of the long rib 12 is hinged to the upper runner, a head end of the linkage rod 13 is hinged to the lower runner, and a tail end of the linkage rod 13 is hinged to the middle of the long rib 12. When the upper runner and the lower runner move toward each other, the head end of the long rib 12 approaches the head end of the linkage rod 13, and the tail end of the linkage rod 13 pushes the middle of the long rib 12 to prop up the long rib 12, thereby opening the canopy, and vice versa. This structure adds more levels of hinged linkage to the folding umbrella, and the essence still lies in that the upper runner and the lower runner move towards or away from each other to unfold or fold the canopy. The canopy is placed on the supporting assemblies.

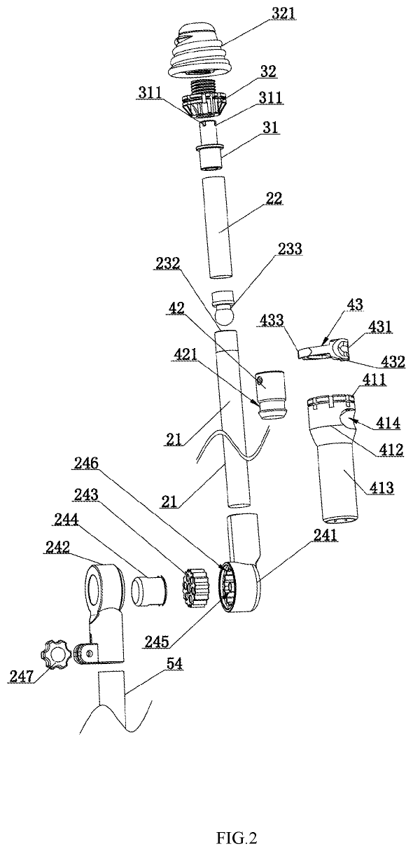

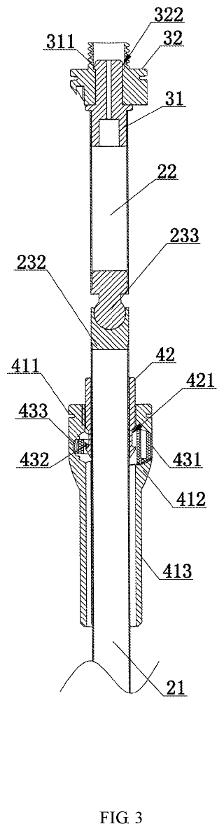

Referring to FIGS. 2 and 3, the upper runner includes a seat 31 and a hinge ring 32. The seat 31 is fixedly arranged at the tail end of the shaft. The seat 31 protrudes to present a cylindrical shape on a side away from the shaft. The hinge ring 32 is rotatably sleeved outside the cylindrical structure. A limiting portion 311 is arranged at an end of the cylindrical structure of the seat 31. The limiting portion 311 is a convex point or a convex edge protruding from a side edge of the cylindrical structure. A limiting groove 322 is arranged on an inner edge of a ring structure of the hinge ring 32. The limiting groove 322 is arranged in cooperation with the limiting portion 311. When the hinge ring 32 is sleeved on the seat 31, the limiting portion 311 is locked into the limiting groove 322 to prevent the hinge ring 32 from being separated from the seat 31. A cap 321 is connected to a side of the hinge ring 32 away from the seat 31. The canopy is sandwiched between an end surface of the hinge ring 32 and the cap 321. The head ends of a plurality of long ribs 12 are hinged to a side edge of the hinge ring 32 in sequence.

FIGS. 1, 2 and 3, the lower runner includes a main body 41. The main body 41 is a hollow tubular structure sleeved outside the shaft. The main body 41 is movable along a length direction of the shaft, and the main body 41 is rotatable around the shaft. The shaft is provided with a limiting groove 421. The limiting groove 421 is an annular groove arranged on a side edge of the shaft. The limiting groove 421 is arranged at a position where the main body 41 is located when the umbrella is opened. The limiting groove 421 is arranged through a limiting base 42 sleeved on the shaft. The limiting base 42 is an annular structure fixedly sleeved outside the shaft, and the limiting groove 421 is arranged in the limiting base 42. The limiting base 42 is fixed to the shaft by a fixing structure or by bonding. The fixing structure used for fixing the limiting base 42 is a bolt, a screw, a rivet or a straight nail.

Referring to FIGS. 2 and 3, the main body 41 sequentially includes a hinge seat 411, a switch seat 412 and a handle 413 which are integrally formed. The hinge seat 411 is used to hinge the head end of the linkage rod 13. An inner diameter of the main body 41 at the switch seat 412 is larger than that at the hinge seat 411 and the handle 413. A button accommodating hole 414 is arranged on a side of the switch seat 412. A switch fastener 43 is arranged in the switch seat 412. The switch fastener 43 has a ring shape. The switch fastener 43 is sandwiched between an outer edge of the shaft and an inner edge of the switch seat 412. An outer edge of the switch fastener 43 is provided with a switch button 431 and two reset springs 433 arranged opposite to each other. The switch button 431 and the reset spring 433 are arranged away from each other. The switch button 431 extends into the button accommodating hole 414. A limiting protrusion 432 is arranged on the inner edge of the switch fastener 43. The limiting protrusion 432 may be clamped into the limiting groove 421 and may be rotatable along a body of the limiting groove 421. The limiting protrusion 432 and the switch button 431 face an identical direction. The limiting protrusion 432 is a rib-shaped structure, which extends in an arc shape in a direction perpendicular to a length direction of the shaft.

Referring to FIGS. 2 and 3, the reset spring 433 is arranged on an outer edge of the switch fastener 43. The reset spring 433 abuts against an inner edge of the switch seat 412. A forced deformation direction of the reset spring 433 is consistent with a movement direction of the switch button 431 after being pressed. The switch button 431 is used to control the limiting protrusion 432 to shrink toward an inner edge of the main body 41 or to protrude from the inner edge of the main body 41. The reset spring 433 is used to support the limiting protrusion 432 when the switch button 431 is not pressed. Since the inner diameter of the main body 41 at the switch seat 412 is larger than that at the hinge seat 411 and the handle 413, a groove for accommodating the switch fastener 43 is defined in the switch seat 412. After the switch fastener 43 is mounted, the switch fastener 43 is limited to the smaller inner diameter of the hinge seat and the handle 413 and is fixed inside the switch seat 412.

Referring to FIGS. 1, 2 and 3, the shaft includes a first shaft body 21 and a second shaft body 22. The second shaft body 22 is deflectively assembled to a tail end of the first shaft body 21. The seat 31 is fixed at a tail end of the second shaft body 22. The main body 41 is movably provided outside the first shaft body 21 along a length direction of the first shaft body 21. A head end of the second shaft body 22 and the tail end of the first shaft body 21 are connected by a deflection mechanism 23. The deflection mechanism 23 is a universal deflection mechanism 23. A deflection angle of the deflection mechanism 23 is restricted to an acute angle. The deflection mechanism 23 includes a deflection ball head 231 and a deflection sleeve 232. The deflection ball head 231 is clamped in the deflection sleeve 232. An inner edge of the deflection sleeve 232 is a spherical structure suitable for the deflection ball head 231. The deflection ball head 231 is arranged at the head end of the second shaft body 22. The deflection sleeve 232 is arranged at the tail end of the first shaft body 21. The supporting rod and the first shaft body 21 are connected by a tilting mechanism 24. The tilting mechanism 24 includes an upper tilting disc 241, a lower tilting disc 242, a limiting gear 243, a reset spring (not shown in the figure) and a tilting button 244. The surfaces of the upper tilting disc 241 and the lower tilting disc 241 are respectively provided with a gear accommodating hole 245. A wall of the gear accommodating hole 245 is provided with a tooth groove 246 matched with the limiting gear 243. Open surfaces of the gear accommodating holes 245 of the upper tilting disc 241 and the lower tilting disc 241 are arranged in close contact with each other. The two gear accommodating holes 245 communicate with each other to define a gear accommodating cavity. The limiting gear 243 is assembled in the gear accommodating cavity. The limiting gear 243 is movable along the tooth groove 246. The upper tilting disc 241 is arranged at the head end of the first shaft body 21. The lower tilting disc 241 is arranged at an upper end of the supporting rod.

Referring to FIGS. 2 and 3, the reset spring and the tilting button 244 are respectively arranged in the gear accommodating holes 245 of the upper tilting disc 241 and the lower tilting disc 241. The reset spring and the tilting button 244 are respectively arranged on two sides of the limiting gear 243 in a thickness direction. The reset spring is sandwiched between the bottom of the gear accommodating hole 245 and an end surface of the limiting gear 243. A bottom end of the tilting button 244 abuts against the other end surface of the limiting gear 243. A head end of the tilting button 244 penetrates the bottom of the gear accommodating hole 245 and extends to the outside of the upper tilting disc 241 or the lower tilting disc 241. In this specific implementation, the reset spring is arranged in the upper tilting disc 241, that is, between a bottom surface of the gear accommodating hole 245 of the upper tilting disc 241 and the end surface of the limiting gear 243. The tilting button 244 penetrates a bottom surface of the gear accommodating hole 245 of the lower tilting disc 241 and extends to the outside of the lower tilting disc. The lower tilting disc 241 is sleeved on the upper end of the supporting rod and is locked by a fastening bolt 247. The limiting base 42 is adjacent to the tail end of the first shaft body 21.

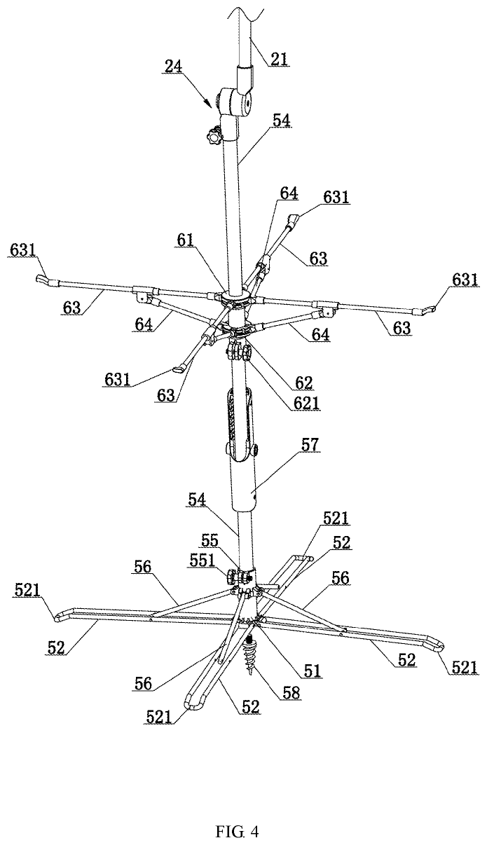

Referring to FIGS. 1 and 4, a supporting base includes a supporting post 51, a plurality of supporting legs 52, a bottom pad 53, a supporting rod 54, a base body sleeve 55, a plurality of base body push-pull rods 56, a ground drill handle 57, a drill bit 58 and a table body. The supporting leg 52 is hinged to a lower end of the supporting post 51. The supporting post 51 is used to connect an object to be supported. The supporting leg 52 is able to be flipped to a supporting base placement surface along a hinge joint of the supporting leg and the supporting post 51 so as to be fixed. The bottom pad 53 is a flexible bottom pad 53. The bottom pad 53 is connected to the supporting legs 52 and arranged under the supporting legs 52. When the supporting leg 52 is flipped to the supporting base placement surface along the hinge joint of the supporting leg and the supporting post 51, the bottom pad 53 is located between the supporting legs 52 and the supporting base placement surface and attached to the supporting base placement surface. In the structure of the plurality of supporting legs 52, there are at least two supporting legs 52. However, the two supporting legs 52 need to satisfy a harsh condition to achieve a stable center of gravity. In this solution, there are preferably at least three supporting legs 52, but four supporting legs 52 are used for illustration in the drawings.

Referring to FIG. 4, the supporting post 51 is provided with an opening on a top surface. A lower end of the supporting rod 54 is inserted into the opening on the top surface of the supporting post 51. The base body sleeve 55 is sleeved outside the supporting rod 54 movably along a length direction of the supporting rod 54. The base body sleeve 55 is arranged above the supporting post 51. The base body push-pull rods 56 are arranged in one-to-one correspondence to the supporting legs 52. A head end of the base body push-pull rod 56 is hinged to the middle of the corresponding supporting leg 52, and a tail end of the base body push-pull rod 56 is hinged to a side edge of the base body sleeve 55. The supporting leg 52 is respectively formed by bending round steel in opposite directions. Ends of the round steel are adjacently connected to form a head end of the supporting legs 52, and a bend in the middle of the round steel forms a tail end of the supporting leg 52. The head end of the supporting leg 52 is hinged to a side edge of the supporting post 51. A supporting portion 521 is arranged at the tail end of each supporting leg 52. The supporting portion 521 is formed by bending the tail end of the supporting leg 52 toward a side of the supporting leg away from the supporting post 51. When the supporting legs 52 are unfolded, the supporting legs 52 and the supporting post 51 are substantially at an angle of 90°. In addition, when the supporting legs 52 are unfolded, a lower end of the base body sleeve 55 abuts against an upper end of the supporting post 51.

Referring to FIGS. 1 and 4, the base body sleeve 55 is provided with a base body bolt 551. The base body bolt 551 is used to fixedly connect the base body sleeve 55 with the supporting rod 54. A bottom surface of the bottom pad 53 is provided with an anti-slip member. The bottom pad 53 is provided with a plurality of extension coverings 531. One extension covering 531 is arranged between each two adjacent supporting legs 52. Adjacent extension coverings 531 are adjacent to each other. Head ends of the plurality of extension coverings 531 are connected to a side edge of the object to be supported above the base body sleeve 55. A weight accommodating cavity for accommodating a weight is formed between the extension coverings 531 and the bottom pad 53. The extension covering 531 is substantially triangular, and all the extension coverings 531 are turned up to their head ends to form a tapered shape.

Referring to FIGS. 1 and 4, the ground drill handle 57 is arranged in the middle of the supporting rod 54, and the drill bit 58 is detachably assembled on a lower end surface of the supporting rod 54. An assembling through-hole is formed in the center of the ground drill handle 57. The supporting rod 54 passes through the assembling through-hole, and is pivotally connected to the ground drill handle 57 through a pivot shaft arranged in the assembling through-hole. Two opposite arcs are arranged at two ends of the ground drill handle 57. The ground drill handle 57 is able to rotate to a position vertical with the supporting rod 54 through a pivot joint, and is also able to rotate until the two arcs are respectively attached to side walls of the supporting rod 54 on upper and lower sides of the pivot joint. The table body is arranged at an upper end of the supporting rod 54. The table body includes an upper table body sleeve 61, a lower table body sleeve 62, at least three struts 63 (indicated as four in the figure), at least three table body push-pull rods 64 and a table top 65. The upper table body sleeve 61 and the lower table body sleeve 62 are respectively sleeved on the supporting rod 54. A head end of the strut 63 is hinged to a side edge of the upper table body sleeve 61. The table body push-pull rods 64 are arranged in one-to-one correspondence to the struts 63. A head end of the table body push-pull rod 64 is hinged to the middle of the corresponding strut 63, and a tail end of the table body push-pull rod 64 is hinged to a side edge of the lower table body sleeve 62. The table top 65 is a flexible table top 65, and the table top 65 is placed on the struts 63. The lower table body sleeve 62 is provided with a sleeve bolt 621. The sleeve bolt 621 is used to fix the lower table body sleeve 62 to the supporting rod 54.

Referring to FIG. 4, the upper table body sleeve 61 and the lower table body sleeve 62 move toward each other to unfold the table top 65, and the upper table body sleeve 61 and the lower table body sleeve 62 move away from each other to fold the table top 65. When the table top 65 is unfolded to a use state, a bottom surface of the upper table body sleeve 61 abuts against a top surface of the lower table body sleeve 62. When the table top 65 is unfolded, relative positions of the upper table body sleeve 61 and the lower table body sleeve 62 and the supporting rod 54 are respectively fixed to maintain the unfolded state of the table top 65. In this embodiment, preferably, the lower table body sleeve 62 is fixed to cooperate with at least one of the following two solutions to maintain the unfolded state of the table top:

First, each strut 63 is provided with a corner strutting member 631. The corner strutting member 631 is arranged at a tail end of the strut 63. The corner strutting member 631 extends toward a side away from the lower table body sleeve 62. The corner strutting member 631 abuts against a lower edge of the table top 65.

Second, the upper table body sleeve 61 is provided with a plurality of hinged limiting portions. The hinged limiting portion is located above a hinge point of the head end of the strut 63. When the table top 65 is stretched, a top surface of the head end of the strut 63 abuts against the hinged limiting portion, and a bottom surface of the strut 63 is at an obtuse angle with the upper table body sleeve 61. The hinged limiting portion is used to prevent the angle between the bottom surface of the strut 63 and the upper table body sleeve 61 from being too large.

Referring to FIGS. 1 and 4, when the table top 65 is unfolded, in the above two solutions, a projection position of a tail end portion of the strut 63 on the supporting rod 54 in a plane perpendicular to the supporting rod 54 is higher than that of a head end portion of the strut 63 on the supporting rod 54 in the plane perpendicular to the supporting rod 54. That is, in the process of unfolding the table top 65, since the table top 65 is flexible, the table top 65 is first expanded and then contracted. Therefore, the table top 65 needs to be unfolded first before the table top 65 is folded. Because the lower table body sleeve 62 is fixed, simply touching the strut 63 or pressing the table top 65 cannot cause the table top 65 to fold. Due to the corner strutting member 631, there is a gap between the table top 65 and the strut 63, so the strut 63 will not affect the flatness of the table top 65. Meanwhile, when an object is placed on the table top 65, the object on the table top 65 is more stable due to the slight deformation of the table top 65. In addition, the stress on the table top 65 is increased, so the possibility of the table top 65 being folded abnormally due to accidental touch is reduced. The table top 65 is provided with a cup holder 651 and a reflective warning portion 652. The cup holder 651 is used to place a cup. The reflective warning portion 652 is arranged on a side of the table top 65 away from the strut 63. The reflective warning portion 652 is a reflective sticker or a reflective coating with a warning function. When the table top 65 is folded, the reflective warning portion 652 achieves a warning effect of the supporting base.

### Embodiment 2

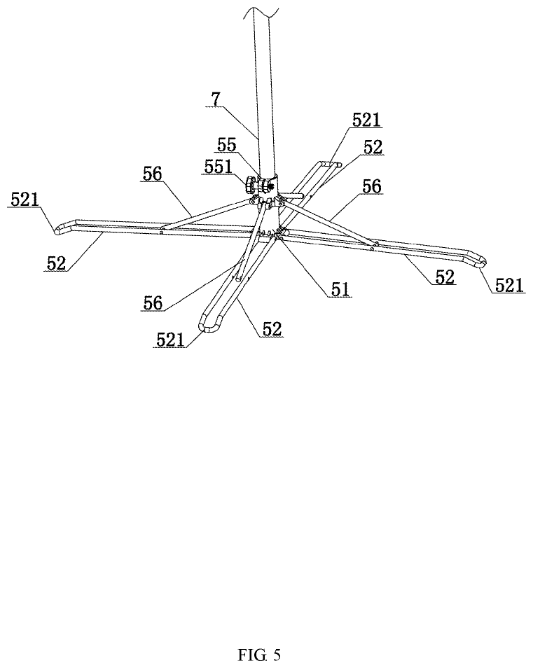

Referring to FIG. 5, a supporting base is used to support a pole-shaped object 7. The pole-shaped object 7 to be supported may be a flagpole, a billboard pole, a warning sign pole and an umbrella support pole, etc. The supporting base includes a supporting post 51, a plurality of supporting legs 52, a bottom pad 53, a base body sleeve 55 and a plurality of base body push-pull rods 56. The supporting leg 52 is hinged to a lower end of the supporting post 51. The supporting post 51 is used to connect the object 7 to be supported. The supporting leg 52 is able to be flipped to a supporting base placement surface along a hinge joint of the supporting leg and the supporting post 51 so as to be fixed. The bottom pad 53 is a flexible bottom pad 53. The bottom pad 53 is connected to the supporting legs 52 and arranged under the supporting legs 52. When the supporting leg 52 is flipped to the supporting base placement surface along the hinge joint of the supporting leg and the supporting post 51, the bottom pad 53 is located between the supporting legs 52 and the supporting base placement surface and attached to the supporting base placement surface. In the structure of the plurality of supporting legs 52, there are at least two supporting legs 52. However, the two supporting legs 52 need to satisfy a harsh condition to achieve a stable center of gravity. In this solution, there are preferably at least three supporting legs 52, but four supporting legs 52 are used for illustration in the drawings.

Referring to FIG. 5, the supporting post 51 is provided with an opening on a top surface. A lower end of the object 7 to be supported is inserted into the opening on the top surface of the supporting post 51. The base body sleeve 55 is sleeved outside the object 7 to be supported movably along a length direction of the object 7 to be supported. The base body sleeve 55 is arranged above the supporting post 51. The base body push-pull rods 56 are arranged in one-to-one correspondence to the supporting legs 52. A head end of the base body push-pull rod 56 is hinged to the middle of the corresponding supporting leg 52, and a tail end of the base body push-pull rod 56 is hinged to a side edge of the base body sleeve 55. The supporting legs 52 are respectively formed by bending round steel in opposite directions. Ends of the round steel are adjacent to each other to form a head end of the supporting legs 52, and a bend in the middle of the round steel forms a tail end of the supporting leg 52. The head end of the supporting leg 52 is hinged to a side edge of the supporting post 51. A supporting portion 521 is arranged at the tail end of each supporting leg 52. The supporting portion 521 is formed by bending the tail end of the supporting leg 52 toward a side of the supporting leg away from the supporting post 51. When the supporting legs 52 are unfolded, the supporting legs 52 and the supporting post 51 are substantially at an angle of 90°. In addition, when the supporting legs 52 are unfolded, a lower end of the base body sleeve 55 abuts against an upper end of the supporting post 51.

Referring to FIG. 5, the base body sleeve 55 is provided with a base body bolt 551. The base body bolt 551 is used to fixedly connect the base body sleeve 55 with the object 7 to be supported. An adjustment washer is arranged in an opening on the top surface of the supporting post 51 and/or in the base body sleeve 55. The adjustment washer is sleeved outside the object 7 to be supported. When the diameter of the object 7 to be supported is small, the adjustment washer is placed on the object 7 to be supported to make the supporting base suitable for the object 7 to be supported with a small diameter. A bottom surface of the bottom pad 53 is provided with an anti-slip member. The bottom pad 53 is provided with a plurality of extension coverings 531. The bottom pad 53 and the extension coverings 531 are the same as those in Embodiment 1.

### Embodiment 3

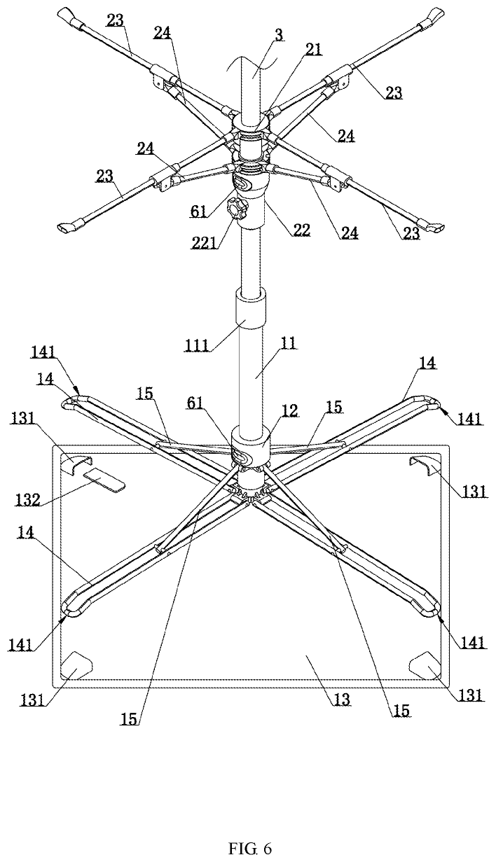

Referring to FIG. 6, a table body and a supporting base are assembled through a supporting rod 3. In this structure, a bottom end of the supporting rod 3 is fixedly placed by using the supporting base, and the table body is assembled to a body of the supporting rod 3. The supporting base includes a supporting post 11, a base body sleeve 12, a base body switch assembly, a bottom pad 13, a plurality of supporting legs 14 and a plurality of base body push-pull rods 15. The base body push-pull rods 15 are arranged in one-to-one correspondence to the supporting legs 14. A head end of the supporting leg 14 is hinged to a circumferential side edge of the bottom of the supporting post 11. A head end of the base body push-pull rod 15 is hinged to the middle of the corresponding supporting leg 14, and a tail end of the base body push-pull rod 15 is hinged to a circumferential side edge of the bottom of the base body sleeve 12. The supporting post 11 is a tubular structure with an opening on a top surface. The opening on the top surface of the supporting post 11 is configured to be inserted by the supporting rod 3. The bottom of the base body sleeve 12 is arranged above the bottom of the supporting post 11. The bottom pad 13 is a flexible bottom pad 13. The bottom pad 13 is connected to the supporting legs 14 and arranged under the supporting legs 14. The bottom of the supporting post 11 and the bottom of the base body sleeve 12 move towards or away from each other to unfold or fold the supporting legs 14. The structures of the supporting leg 14 and the base body push-pull rod 15 are involved in the background art, and will not be repeated here.

Referring to FIG. 6, the base body sleeve 12 is movable along the supporting post 11 and sleeved outside the supporting post 11. When the supporting legs 14 are in an unfolded state, the base body switch assembly is used to lock the relative movement between the base body sleeve 12 and the supporting post 11 or to remove the locked state. When the supporting legs 14 are in an unfolded state, the bottom pad 13 is located between the supporting legs 14 and a supporting base placement surface and attached to the supporting base placement surface. A supporting portion 141 is arranged at the tail end of each supporting leg 14. The supporting portion 141 is formed by bending the tail end of the supporting leg 14 toward a side of the supporting leg away from the supporting post 11. There are four supporting legs 14 and four base body push-pull rods 15. The bottom pad 13 is arranged in a square shape. Four corners of a top surface of the bottom pad 13 are respectively provided with a connecting sleeve 131. The bottom pad 13 is sleeved outside the supporting portion 141 through the connecting sleeve 131 to realize connection with the supporting leg 14. The bottom pad 13 is further provided with a disassembling handle 132. The disassembling handle 132 is a flexible handle, and the disassembling handle 132 is arranged in any one of the four corners of the bottom pad 13. Since the bottom pad 13 is located at a bottom surface of the supporting base, it is easy to get dirty and thus needs to be removed and washed. While this structure ensures the supporting function of the supporting leg 14, the bottom pad 13 is assembled to the supporting portion 141 through the connecting sleeve 131 to ensure the connection strength between the bottom pad 13 and the supporting leg 14 and to facilitate the disassembly and assembly of the bottom pad 13. In particular, thanks to the cooperation of the disassembling handle 132, during the process of assembling the bottom pad 13, the other three supporting portions 141 may be inserted into the connecting sleeves 131 first, and then the last supporting portion may be pulled into the last corner of the bottom pad 13 through the disassembling handle 132. In the process of disassembling the bottom pad 13, the corner of the bottom pad 13 adjacent to the disassembling handle 132 may be disassembled first by the disassembling handle.

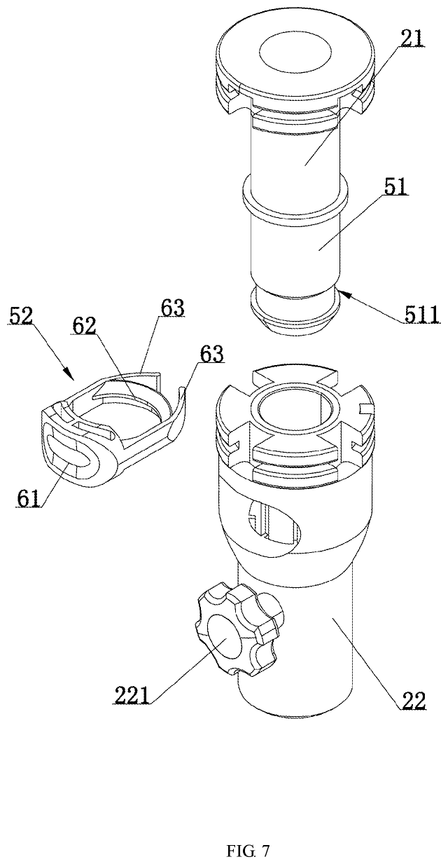

Referring to FIGS. 6 and 7, the base body switch assembly is a structure in which a latch mechanism arranged in one of the supporting post 11 and the base body sleeve 12 is locked into the other of the supporting post 11 and the base body sleeve 12. Alternatively, the base body switch assembly is a structure in which a pressing mechanism arranged in one of the supporting post 11 and the base body sleeve 12 presses a side edge of the other of the supporting post 11 and the base body sleeve 12. Regarding the realization of the base body switch assembly, those skilled in the art may select a suitable structure from those described above, such as a switch button 61, a bow switch or a screw locking mechanism commonly used in outdoor umbrellas and automatic umbrellas. Specifically, the base body switch assembly includes a base body limiting base 41 and a base body switch fastener 42. The base body limiting base 41 and the supporting post 11 are integrally formed by injection molding on a circumferential outer edge of the supporting post 11. The base body switch fastener 42 is assembled in the base body sleeve 12. The circumferential outer edge of the base body limiting base 41 is provided with a limiting groove 411 with a ring-shaped structure. The base body switch fastener 42 is arranged in a ring shape.

Referring to FIGS. 6 and 7, specifically, the base body switch fastener 42 is provided with a switch button 61, a limiting protrusion 62 and two reset springs 63. The switch button 61 is arranged on a circumferential outer edge of the ring structure of the base body switch fastener 42. The limiting protrusion 62 is arranged on a circumferential inner edge of the ring structure of the base body switch fastener 42. The switch button 61 penetrates a side wall of the base body sleeve 12 and extends to a circumferential outer edge of the base body sleeve 12. A protruding direction of the limiting protrusion 62 and an extending direction of the switch button 61 are identical. The reset spring 63 and the limiting protrusion 62 are arranged away from each other on the circumferential outer edge of the ring structure of the base body switch fastener 42. The reset spring 63 abuts against an inner edge of the base body sleeve 12. A forced deformation direction of the reset spring 63 is consistent with a movement direction of the switch button 61 after being pressed. The two reset springs 63 are arranged opposite to each other. The supporting post 11 is provided with a top fixing portion 111 and a bottom fixing portion. The top fixing portion 111 is arranged at the opening on the top surface of the supporting post 11. The top fixing portion 111 is a threaded variable-diameter locking structure. The bottom fixing portion is arranged at the bottom of the supporting post 11. The bottom fixing portion is a necking structure with an inner diameter gradually decreasing from top to bottom. A common threaded variable-diameter locking structure is realized, for example, by a structure in which the shaft of an outdoor umbrella is connected to a lower rod thereof. Specifically, a friction plate with a certain movable elasticity cooperates with a turning wheel that moves and presses the friction plate through a threaded structure to realize a variable-inner-diameter locking structure. Since the supporting rod 3 needs to be accommodated in the supporting post 11, the base body limiting base 41 and the supporting post 11 cannot be connected by a rivet that occupies the interior of the supporting post 11. In addition, in order to ensure that the inner diameter of the bottom fixing portion is gradually reduced from top to bottom, preferably, the base body limiting base 41, the supporting post 11 and the bottom fixing portion are integrated by injection molding, which is convenient for production and low-cost.

Referring to FIG. 6, the table body includes an upper table body sleeve 21, a lower table body sleeve 22, at least three struts 23, at least three table body push-pull rods 24, a table body switch assembly and a table top. A head end of the strut 23 is hinged to a top side edge of the upper table body sleeve 21. The table body push-pull rods 24 are arranged in one-to-one correspondence to the struts 23. A head end of the table body push-pull rod 24 is hinged to the middle of the corresponding strut 23, and a tail end of the table body push-pull rod 24 is hinged to a top side edge of the lower table body sleeve 22. The table top is a flexible table top. The table top is placed on the struts 23. The top of the upper table body sleeve 21 and the top of the lower table body sleeve 22 move towards or away from each other to unfold or fold the struts 23. The table top structure is not shown in the figure, and the specific table top connection structure may refer to the connection mode of the bottom pad 13 and the supporting portion 141. The table body is placed in an application position through a supporting rod 3. The upper table body sleeve 21 and the lower table body sleeve 22 are respectively sleeved outside the supporting rod 3. A handle wheel 221 drives the threaded pressing structure in the lower table body sleeve 22 so as to be fixed to the supporting rod 3.

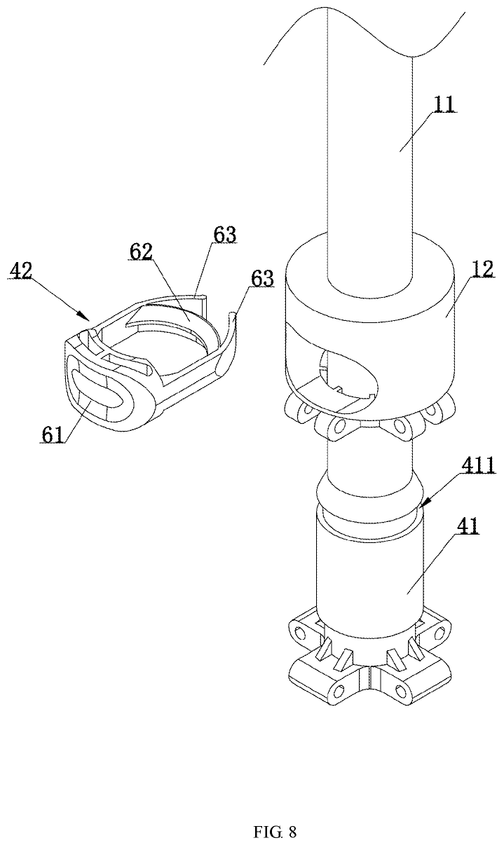

Referring to FIGS. 6 and 8, when the struts 23 are in an unfolded state, the bottom of the upper table body sleeve 21 is located in the lower table body sleeve 22, and the table body switch assembly is used to lock the relative movement between the upper table body sleeve 21 and the lower table body sleeve 22 or to remove the locked state. The table body switch assembly is a structure in which a latch mechanism arranged in one of the upper table body sleeve 21 and the lower table body sleeve 22 is locked into the other of the upper table body sleeve 21 and the lower table body sleeve 22. Alternatively, the table body switch assembly is a structure in which a pressing mechanism arranged on one of the upper table body sleeve 21 and the lower table body sleeve 22 presses a side edge of the other of the upper table body sleeve 21 and the lower table body sleeve 22. Regarding the realization of the table body switch assembly, those skilled in the art may select a suitable structure from those described above, such as a switch button 61, a bow switch or a screw locking mechanism commonly used in outdoor umbrellas and automatic umbrellas. In order to facilitate the unfolding and folding of the table body, the table body switch assembly is arranged under the lower table body sleeve 22 under a hinge joint at the tail end of the table body push-pull rod 24, and the handle wheel 221 for fixing the lower table body sleeve 22 to the supporting rod 3 is arranged at a bottom end of the lower table body sleeve 22. In specific assembly, the table body may be unfolded first, and then the supporting rod 3 is inserted into the lower table body sleeve 22 and extends out from the top of the upper table body sleeve 21. Alternatively, the supporting rod 3 may be inserted into the upper table body sleeve 21 and the lower table body sleeve 22 when the table body is in a folded state, and then the table body is unfolded.

Referring to FIGS. 6 and 8, specifically, the table body switch assembly includes a table body limiting base 51 and a table body switch fastener 52. The table body limiting base 51 and the upper table body sleeve 21 are integrally formed on a circumferential outer edge of the supporting post 11. The table body switch fastener 52 is assembled in the lower table body sleeve 22. A circumferential outer edge of the table body limiting base 51 is provided with a limiting groove 511 with a ring-shaped structure. The table body switch fastener 52 is arranged in a ring shape. The table body switch fastener 52 is provided with the switch button 61, the limiting protrusion 62 and the two reset springs 63. The table body switch fastener 52 is similar in structure to the base body switch fastener 42, and the difference lies in the size and other aspects of fit, which will not be repeated here. In this specific implementation, the limiting groove 511 is arranged at a bottom end of the upper table body sleeve 21. Those skilled in the art may also extend the upper table body sleeve 21 until the table body is in a folded state according to the above solution, and the lower table body sleeve 22 is still sleeved outside the upper table body sleeve 21. In this structure, the top end and/or bottom end of the upper table body sleeve 21 may be fixed to the supporting rod 3.

The above described are merely specific implementations of the present invention, but the design concept of the present invention is not limited thereto. Any non-substantial changes made to the present invention based on the concept of the present invention should fall within the protection scope of the present invention.

What is claimed is:

1. A supporting base, comprising a supporting post, a plurality of supporting legs and a bottom pad, wherein the plurality of supporting legs are hinged to a lower end of the supporting post; the supporting post is configured to connect an object to be supported; the plurality of supporting leg is configured to be flipped to a supporting base placement surface along a hinge joint of the supporting leg and the supporting post to be fixed; the bottom pad is a flexible bottom pad; the bottom pad is connected to the plurality of supporting legs and arranged under the plurality of supporting legs; when the supporting leg is flipped to the supporting base placement surface along the hinge joint of the supporting leg and the supporting post, the bottom pad is located between the plurality of supporting legs and the supporting base placement surface and attached to the supporting base placement surface.

2. The supporting base according to claim 1, further comprising a base body sleeve and a plurality of base body push-pull rods; wherein the supporting post is provided with an opening on a top surface; the opening on the top surface of the supporting post is configured to be inserted by a pole-shaped object to be supported; the base body sleeve is sleeved outside the object to be supported; the base body sleeve is arranged above the supporting post; the plurality of base body push-pull rods are arranged in one-to-one correspondence to the plurality of supporting legs; a head end of the base body push-pull rod is hinged to a middle of the corresponding supporting leg, and a tail end of the base body push-pull rod is hinged to a side edge of the base body sleeve.

3. The supporting base according to claim 2, wherein the base body sleeve is provided with a base body bolt; the base body bolt is locked and fastened to fixedly connect the base body sleeve with the object to be supported by locking and fastening; an adjustment washer is arranged in the opening on the top surface of the supporting post and/or in the base body sleeve; the adjustment washer is sleeved outside the object to be supported.

4. The supporting base according to claim 2, wherein a bottom surface of the bottom pad is provided with an anti-slip member; the bottom pad is provided with a plurality of extension coverings; one extension covering of the plurality of extension coverings is arranged between each two adjacent supporting legs of the plurality of supporting legs; adjacent extension coverings of the plurality of extension coverings are adjacent to each other; head ends of the plurality of extension coverings are connected to a side edge of the object to be supported above the base body sleeve; a weight accommodating cavity for accommodating a weight is formed between the plurality of extension coverings and the bottom pad.

5. The supporting base according to claim 1, wherein head ends of the plurality of supporting legs are hinged to a side edge of the supporting post; a supporting portion is arranged at a tail end of each supporting leg of the plurality of supporting legs; the supporting portion is formed by bending the tail end of the supporting leg toward a side of the supporting leg, wherein the side of the supporting leg is away from the supporting post.

6. The supporting base according to claim 1, further comprising a supporting rod, a base body sleeve and a plurality of base body push-pull rods; wherein the supporting post is provided with an opening on a top surface; a lower end of the supporting rod is inserted into the opening on the top surface of the supporting post; the base body sleeve is sleeved outside the supporting rod movably along a length direction of the supporting rod; the base body sleeve is arranged above the supporting post; the plurality of base body push-pull rods are arranged in one-to-one correspondence to the plurality of supporting legs; a head end of the base body push-pull rod is hinged to a middle of the corresponding supporting leg, and a tail end of the base body push-pull rod is hinged to a side edge of the base body sleeve.

7. The supporting base according to claim 6, further comprising a ground drill handle and a drill bit; the ground drill handle is arranged in a middle of the supporting rod, and the drill bit is detachably assembled on a lower end surface of the supporting rod; an assembling through-hole is formed in a center of the ground drill handle; the supporting rod passes through the assembling through-hole, and is pivotally connected to the ground drill handle through a pivot shaft arranged in the assembling through-hole.

8. The supporting base according to claim 6, further comprising a table body; wherein the table body is arranged at an upper end of the supporting rod; the table body comprises an upper table body sleeve, a lower table body sleeve, at least three struts, at least three table body push-pull rods and a table top; the upper table body sleeve and the lower table body sleeve are respectively sleeved on the supporting rod; head ends of the at least three struts are hinged to a side edge of the upper table body sleeve; the at least three table body push-pull rods are arranged in one-to-one correspondence to the at least three struts; a head end of the table body push-pull rod is hinged to a middle of the corresponding strut, and a tail end of the table body push-pull rod is hinged to a side edge of the lower table body sleeve; the table top is a flexible table top, and the table top is placed on the at least three struts.

9. The supporting base according to claim 8, wherein the table top is provided with a reflective warning portion; the reflective warning portion is arranged on a side of the table top, wherein the side of the table top is away from the struts; the reflective warning portion is a reflective sticker or a reflective coating with a warning function.

10. An outdoor umbrella using the supporting base according to claim 1, wherein the outdoor umbrella is fixedly placed by using the supporting base.

11. A supporting base, comprising a supporting post, a base body sleeve, a plurality of supporting legs, a plurality of base body push-pull rods, and a base body switch assembly; wherein the plurality of base body push-pull rods are arranged in one-to-one correspondence to the plurality of supporting legs; head ends of the plurality of supporting legs are hinged to a circumferential side edge of a bottom of the supporting post; a head end of the base body push-pull rod is hinged to a middle of the corresponding supporting leg, and a tail end of the base body push-pull rod is hinged to a circumferential side edge of a bottom of the base body sleeve; the supporting post is a tubular structure with an opening on a top surface; the opening on the top surface of the supporting post is configured to be inserted by a pole-shaped object to be supported; the bottom of the base body sleeve is arranged above the bottom of the supporting post; the bottom of the supporting post and the bottom of the base body sleeve move towards or away from each other to unfold or fold the supporting legs; the base body sleeve is movably sleeved outside the supporting post; when the plurality of supporting legs are in an unfolded state, the base body switch assembly is configured to lock a relative movement between the base body sleeve and the supporting post or to remove a locked state.

12. The supporting base according to claim 11, further comprising a bottom pad; wherein the bottom pad is a flexible bottom pad; the bottom pad is connected to the plurality of supporting legs and arranged under the plurality of supporting legs; when the plurality of supporting legs are in an unfolded state, the bottom pad is located between the plurality of supporting legs and a supporting base placement surface and attached to the supporting base placement surface.

13. The supporting base according to claim 12, wherein a supporting portion is arranged at a tail end of each supporting leg; the supporting portion is formed by bending the tail end of the supporting leg toward a side of the supporting leg, wherein the side of the supporting leg is away from the supporting post.

14. The supporting base according to claim 13, wherein four supporting legs and four base body push-pull rods are arranged respectively; the bottom pad is arranged in a square shape; four corners of a top surface of the bottom pad are respectively provided with a connecting sleeve; the bottom pad is sleeved outside the supporting portion through the connecting sleeve to realize connection with the supporting leg; the bottom pad is further provided with a disassembling handle; the disassembling handle is a flexible handle, and the disassembling handle is arranged in any one of the four corners of the bottom pad.

15. The supporting base according to claim 11, wherein the base body switch assembly has a first structure, wherein in the first structure, a latch mechanism arranged in one of the supporting post and the base body sleeve is locked into the other of the supporting post and the base body sleeve; or, the base body switch assembly has a second structure, wherein in the second structure, a pressing mechanism arranged in one of the supporting post and the base body sleeve presses a side edge of the other of the supporting post and the base body sleeve.

16. The supporting base according to claim 15, wherein the base body switch assembly comprises a base body limiting base and a base body switch fastener; the base body limiting base and the supporting post are integrally formed on a circumferential outer edge of the supporting post; the base body switch fastener is assembled in the base body sleeve; a circumferential outer edge of the base body limiting base is provided with a limiting groove with a ring-shaped structure; the base body switch fastener is arranged in a ring shape; the base body switch fastener is provided with a switch button, a limiting protrusion and at least one reset spring; the switch button is arranged on a circumferential outer edge of a ring structure of the base body switch fastener; the limiting protrusion is arranged on a circumferential inner side edge of the ring structure of the base body switch fastener; the switch button penetrates a side wall of the base body sleeve and extends to a circumferential outer edge of the base body sleeve; a protruding direction of the limiting protrusion and an extending direction of the switch button are identical; the at least one reset spring and the limiting protrusion are arranged away from each other on the circumferential outer edge of the ring structure of the base body switch fastener; the at least one reset spring abuts against an inner edge of the base body sleeve.

17. The supporting base according to claim 11, wherein the supporting post is provided with a top fixing portion and a bottom fixing portion; the top fixing portion is arranged at the opening on the top surface of the supporting post; the top fixing portion is a threaded variable-diameter locking structure; the bottom fixing portion is arranged at the bottom of the supporting post; the bottom fixing portion is a necking structure with an inner diameter gradually decreasing from top to bottom.

18. A table body using the supporting base according to claim 11, comprising an upper table body sleeve, a lower table body sleeve, at least three struts, at least three table body push-pull rods, a table top, and a table body switch assembly; wherein head ends of the at least three struts is hinged to a side edge of the upper table body sleeve; the at least three table body push-pull rods are arranged in one-to-one correspondence to the at least three struts; a head end of a table body push-pull rod is hinged to a middle of the corresponding strut, and a tail end of the table body push-pull rod is hinged to a side edge of the lower table body sleeve; the table top is a flexible table top, and the table top is placed on the at least three struts; a top of the upper table body sleeve and a top of the lower table body sleeve move towards or away from each other to unfold or fold the at least three struts; the table body is placed in an application position through a supporting rod; when the at least three struts are in an unfolded state, a bottom of the upper table body sleeve is located in the lower table body sleeve, and the table body switch assembly is configured to lock a relative movement between the upper table body sleeve and the lower table body sleeve or to remove a locked state; the upper table body sleeve and the lower table body sleeve are respectively sleeved outside the supporting rod; at least one of the upper table body sleeve and the lower table body sleeve is connected to the supporting rod.

19. The outdoor umbrella according to claim 10, wherein the supporting base further comprises a base body sleeve and a plurality of base body push-pull rods; the supporting post is provided with an opening on a top surface; the opening on the top surface of the supporting post is configured to be inserted by a pole-shaped object to be supported; the base body sleeve is sleeved outside the object to be supported; the base body sleeve is arranged above the supporting post; the plurality of base body push-pull rods are arranged in one-to-one correspondence to the plurality of supporting legs; a head end of the base body push-pull rod is hinged to a middle of the corresponding supporting leg, and a tail end of the base body push-pull rod is hinged to a side edge of the base body sleeve.

20. The outdoor umbrella according to claim 19, wherein the base body sleeve is provided with a base body bolt; the base body bolt is locked and fastened to fixedly connect the base body sleeve with the object to be supported by locking and fastening; an adjustment washer is arranged in the opening on the top surface of the supporting post and/or in the base body sleeve; the adjustment washer is sleeved outside the object to be supported.
